(19) United States
(12) Patent Application Publication
(10) Pub. No.: US 2025/0184585 A1
(43) Pub. Date: Jun. 5, 2025

(54) EMBEDDED ELECTRONIC DEVICE

(71) Applicant: Kuo-Chen LIU, Taichung City (TW)

(72) Inventor: Kuo-Chen LIU, Taichung City (TW)

(21) Appl. No.: 18/961,717

(22) Filed: Nov. 27, 2024

(30) Foreign Application Priority Data
Nov. 30, 2023 (TW) 112146666

(51) Int. Cl. H04N 23/51; H04N 23/54

(52) U.S. Cl. CPC H04N 23/51; H04N 23/54

(57) ABSTRACT

An embedded electronic device includes a movable unit, an electrical assembly unit, a fixing unit, and a pushing unit. The movable unit includes a main body and at least one buffer block. The fixing unit includes a top cover that covers the main body. The top cover has a body through hole that allows the main body and the at least one buffer block to move therethrough for protruding upwardly from or retracting downwardly into the top cover. The pushing unit resiliently biases the movable unit to move upwardly until the movable unit is stopped and positioned by the top cover. The movable unit is movable relative to the top cover along an axis between a hidden position, in which the movable unit retracts into the top cover, and an exposed position, in which the movable unit protrudes from the top cover.

### CROSS-REFERENCE TO RELATED APPLICATION

This application claims priority to Taiwanese Invention Patent Application No. 112146666, filed on Nov. 30, 2023, the entire disclosure of which is incorporated by reference herein.

### FIELD

The present disclosure relates to an electronic device, and more particularly to an embedded electronic device that provides shock or impact prevention.

### BACKGROUND

An embedded camera device disclosed in Taiwanese Utility Model Patent No. TW M613848 is adapted to capture a license plate of a vehicle. The embedded camera device includes a casing that is embedded in a ground, and a camera unit that is fixedly disposed in the casing and that has a lens module located above a surface of the ground. Although the embedded camera device is capable of capturing a license plate via the lens module, it is still desirable to provide a greater selection of embedded camera devices to consumers.

### SUMMARY

Therefore, an object of the disclosure is to provide an embedded electronic device having a configuration different from the abovementioned prior art.

According to the disclosure, the embedded electronic device includes a movable unit, an electrical assembly unit, a fixing unit, and a pushing unit. The movable unit includes a main body and at least one buffer block. The main body has a top wall, and a surrounding wall that extends downwardly from a periphery of the top wall, that has a bottom end opposite to the top wall, and that surrounds an axis of the main body. The top wall and the surrounding wall cooperatively define a receiving space. The at least one buffer block is disposed on the surrounding wall, and has an upward-facing inclined surface that has an inner upper end which is proximate to the top wall and an outer lower end which is lower than and more distant from the axis compared to the inner upper end. The upward-facing inclined surface is inclined downwardly and outwardly from the inner upper end to the outer lower end to extend away from the axis. The electrical assembly unit is fixedly connected to the main body and located in the receiving space, and includes an electronic module. The fixing unit includes a top cover that covers the main body. The top cover has a body through hole that allows the main body and the at least one buffer block to move therethrough for protruding upwardly from or retracting downwardly into the top cover. The pushing unit resiliently biases the movable unit to move upwardly until the movable unit is stopped and positioned by the top cover. The movable unit is movable relative to the top cover of the fixing unit along the axis between a hidden position, in which the movable unit retracts into the top cover, and an exposed position, in which the movable unit protrudes from the top cover.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a first embodiment of an embedded electronic device according to the present disclosure, illustrating a movable unit of the first embodiment in an exposed position.

FIG. 2 is a partly exploded perspective view of the first embodiment.

FIG. 3 is a partly exploded perspective view of part of the first embodiment, illustrating the movable unit, an electrical assembly unit of the first embodiment, a top cover of a fixing unit of the first embodiment, and a cleaning unit of the first embodiment.

FIG. 4 is a top perspective view of part of the movable unit, illustrating a main body of the movable unit.

FIG. 5 is a bottom perspective view of the part of the movable unit, illustrating the main body.

FIG. 6 is a partly exploded perspective view of different part of the first embodiment, illustrating the main body, a guiding unit of the first embodiment, and a pushing unit of the first embodiment.

FIG. 7 is another partly exploded perspective view of the first embodiment, illustrating the movable unit and the fixing unit.

FIG. 8 is a top perspective view of an outer casing of the fixing unit.

FIG. 9 is a fragmentary sectional view illustrating that the first embodiment is embedded in a ground and that the movable unit is in the exposed position.

FIG. 10 is a view similar to FIG. 1, but not showing the outer casing to clearly illustrate the movable unit in a hidden position and springs of the pushing unit.

FIG. 11 is a view similar to FIG. 9, but illustrating the movable unit in the hidden position.

FIG. 12 is a fragmentary sectional view illustrating a second embodiment of the embedded electronic device according to the present disclosure embedded in a ground.

FIG. 13 is a perspective view of a third embodiment of the embedded electronic device according to the present disclosure, illustrating a movable unit of the third embodiment in an exposed position.

FIG. 14 is a sectional view of the third embodiment, illustrating the movable unit of the third embodiment in the exposed position.

FIG. 15 is a perspective view of the third embodiment, illustrating the movable unit of the third embodiment in an hidden position.

FIG. 16 is a sectional view of the third embodiment, illustrating the movable unit of the third embodiment in the hidden position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

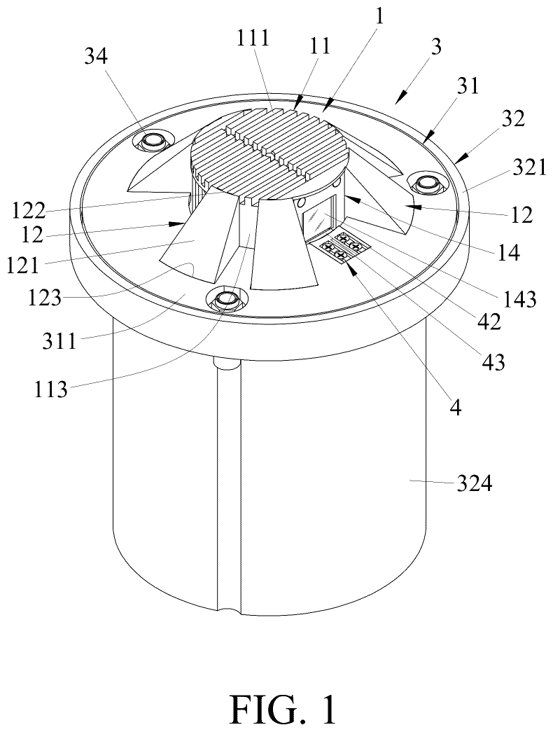

Referring to FIGS. 1, 2, and 9, a first embodiment of an embedded electronic device according to the present disclosure is adapted to be fixedly embedded in a ground 8, and includes a movable unit 1, an electrical assembly unit 2, a fixing unit 3, a cleaning unit 4, a guiding unit 5, a pushing unit 6, and a light emitting element 7.

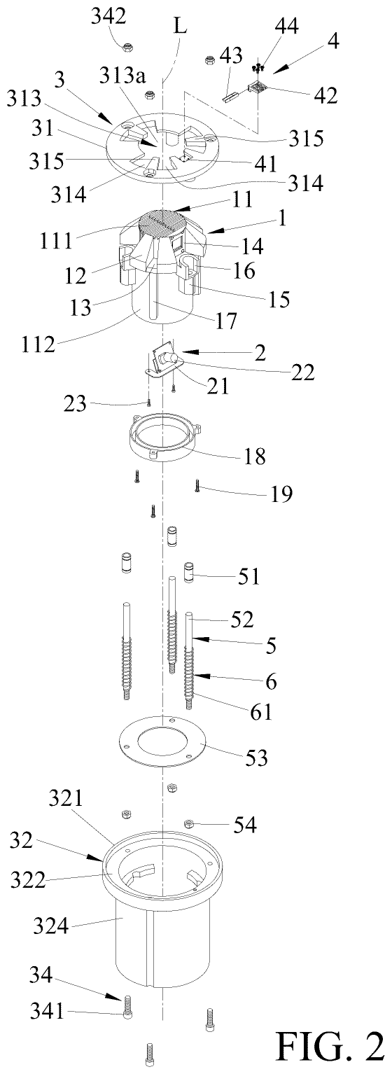

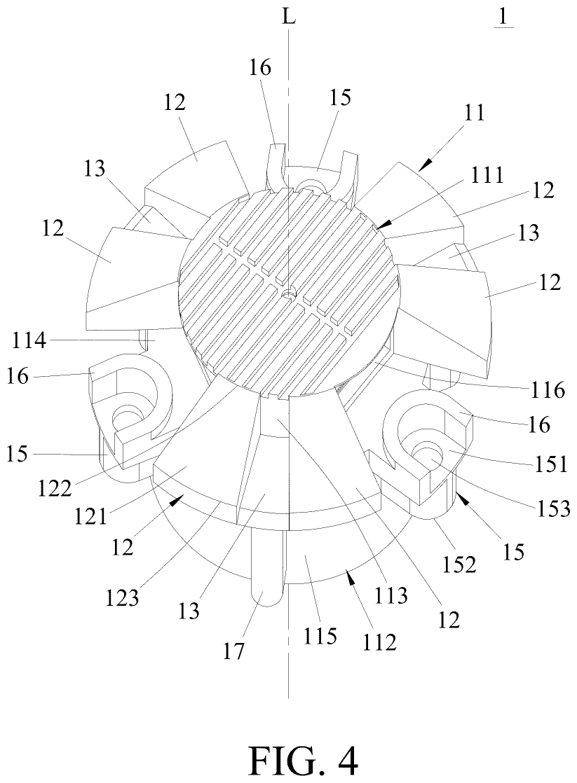

Referring to FIGS. 2, 3, and 4, the movable unit 1 includes a main body 11, a plurality of buffer blocks 12, a plurality of limiting blocks 13, a protective plate 14, a plurality of guide blocks 15, a plurality of curved frame blocks 16, a plurality of protruding ribs 17, and a bottom cover 18.

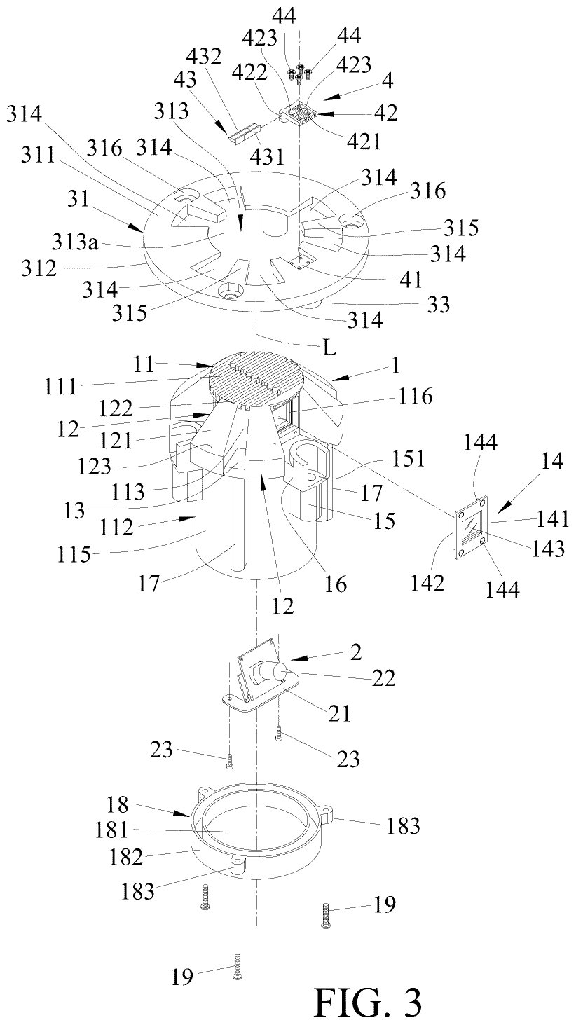

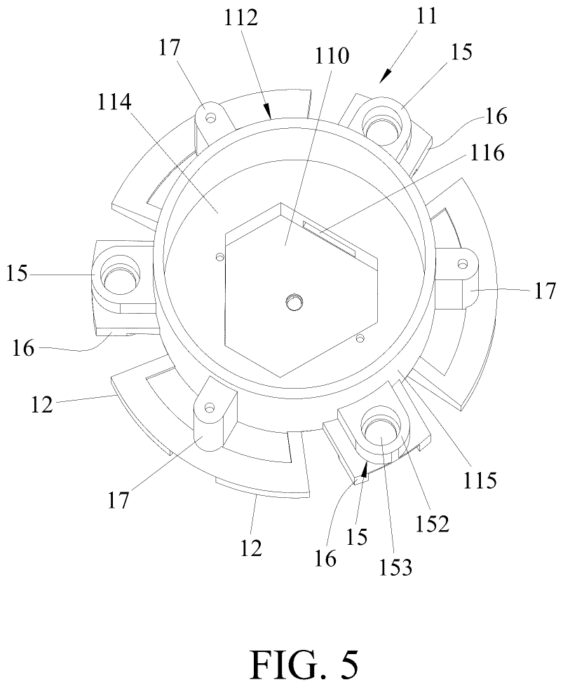

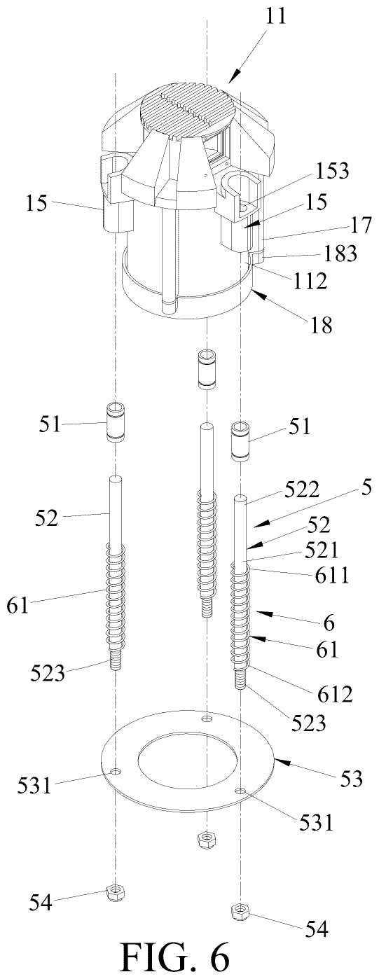

Referring to FIGS. 3, 4, 5, 6, and 9, the main body 11 has a top wall 111, and a surrounding wall 112 that extends downwardly from a periphery of the top wall 111, that has a bottom end opposite to the top wall 111, and that surrounds an axis (L) of the main body 11. The top wall 111 and the surrounding wall 112 cooperatively define a receiving space 110.

A cross section of the surrounding wall 112 parallel to the axis (L) is generally in the shape of two-tier cake. The surrounding wall 112 has a narrowed portion 113 that extends downwardly from the periphery of the top wall 111 along the axis (L), a shoulder portion 114 that extends from a bottom end of the narrowed portion 113 in a radially outward direction relative to the axis (L), and a broadened portion 115 that extends downwardly from an outer periphery of the shoulder portion 114 toward the bottom end of the surrounding wall 112. The narrowed portion 113 has a window hole 116 that extends therethrough in a radial direction relative to the axis (L), and that communicates with the receiving space 110.

The buffer blocks 12 are disposed on the narrowed portion 113 of the surrounding wall 112, are angularly spaced apart around the narrowed portion 113, and extend in the radially outward direction relative to the axis (L). Each of the buffer blocks 12 has a upward-facing inclined surface 121 that has an inner upper end 122 which is disposed in close proximity to the periphery of the top wall 111, and an outer lower end 123 which is lower than and more distant from the axis (L) compared to the inner upper end 122 and which is disposed in close proximity to the outer periphery of the shoulder portion 114. The upward-facing inclined surface 121 is inclined downwardly and outwardly from the inner upper end 122 to the outer lower end 123 to extend away from the axis (L). In this embodiment, the movable unit 1 includes six buffer blocks 12 that are divided into three buffer block pairs which are equiangularly disposed about the axis (L). The window hole 116 is located between two of the buffer block pairs.

The limiting blocks 13 are disposed on the shoulder portion 114 of the surrounding wall 112, and are located lower than the window hole 116. In this embodiment, the movable unit 1 includes three limiting blocks 13, and each of the limiting blocks 13 is located between the buffer blocks 12 in a respective one of the buffer block pairs.

The protective plate 14 includes an outer frame 141 that is fixedly connected to the narrowed portion 113 of the surrounding wall 112 and that is located outside the window hole 116, a lens frame 142 that is fixedly connected to the outer frame 141 and that is located in the window hole 116, and a transparent plate 143 that is mounted in the lens frame 142 and that seals the window hole 116. In this embodiment, a plurality of fastening members 144 extend through the outer frame 141 into the narrowed portion 113 such that the outer frame 141 is fixedly connected to the narrowed portion 113. The fastening members 144 may be screws or nails. It is noted that, the number of each of the protective plate 14 and the window hole 116 may be two or three.

The guide blocks 15 are equiangularly disposed on an outer surface of the broadened portion 115 of the surrounding wall 112 about the axis (L). Each of the guide blocks 15 has a top surface 151, a bottom surface 152, and a guide hole 153 that extends therethrough along the axis (L) (i.e., the guide hole 153 extends from the top surface 151 to the bottom surface 152 along the axis (L)).

The curved frame blocks 16 are disposed on the outer periphery of the shoulder portion 114, respectively extend upwardly from the top surfaces 151 of the guide blocks 15, and are located lower than the window hole 116.

The protruding ribs 17 are disposed on the broadened portion 115, extend parallel to the axis (L), and respectively extend downwardly from bottom portions of the limiting blocks 13.

The bottom cover 18 is fixedly connected to a bottom end of the broadened portion 115 (i.e., the bottom end of the surrounding wall 112), and has a bottom plate 181, an outer ring 182 that extends upwardly from an outer periphery of the bottom plate 181 and that is sleeved on the broadened portion 115, and a plurality of fastening lugs 183 that are respectively fastened to the protruding ribs 17. In this embodiment, a plurality of screws 19 respectively extend through the fastening lugs 183 and into the protruding ribs 17 along the axis (L) to fasten the fastening lugs 183 to the protruding ribs 17 such that the bottom cover 18 is fixedly connected to the bottom end of the broadened portion 115 and closes the receiving space 110.

The electronic assembly unit 2 includes a fixed frame 21 that is fixedly mounted to the main body 11 and that is located in the receiving space 110, and an electronic module 22 that is mounted to the fixed frame 21, that is disposed in the narrowed portion 113 of the surrounding wall 112, that is near the window hole 116 of the narrowed portion 113, and that is located in the receiving space 110. The electronic module 22 may be a camera module that is configured to capture a license plate of a vehicle, a projection module that is configured to project images onto a predetermined location for an advertisement, or a lighting module that is configured to emit light. Any one of the abovementioned operations of the electronic module 22 works via the window hole 116 and the transparent plate 143. In one embodiment, the electronic module 22 may be a geomagnetic sensor that is configured to detect whether a vehicle is parked in a parking space, and the window hole 116 may be omitted when the electronic module 22 is a geomagnetic sensor.

In this embodiment, two screws 23 threadedly engage the fixed frame 21 and the shoulder portion 114 of the main body 11 so that the fixed frame 21 is fixedly mounted to the shoulder portion 114. It is noted that, the fixed frame 21 may not be limited to be fixedly mounted only to the shoulder portion 114, and may be fixedly mounted to another portion of the main body 11. In addition, the manner in which the fixed frame 21 and the main body 11 are connected may not be limited to the disclosure herein. In one embodiment, the fixed frame 21 may be adhered to the shoulder portion 114.

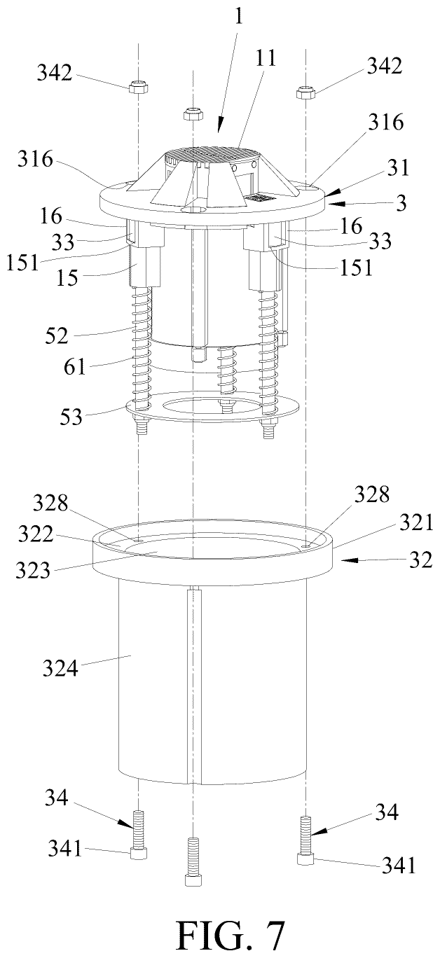

Referring to FIGS. 1, 2, 3, and 7, the fixing unit 3 includes a top cover 31 that covers the main body 11 of the movable unit 1, an outer casing 32 that is located outside the top cover 31, a plurality of column legs 33 that extend downwardly from the top cover 31 along the axis (L), and a plurality of lock assemblies 34 that extend through the top cover 31 and the outer casing 32 to fasten the top cover 31 to the outer casing 32.

The top cover 31 has a top surface 311, a bottom surface 312, a body through hole 313 that extends from the top surface 311 to the bottom surface 312, that allows the top wall 111 of the main body 11 and the narrowed portion 113 of the surrounding wall 112 to move therethrough for protruding upwardly from or retracting downwardly into the top cover 31, that has a main hole portion 313a and a plurality of block through holes 314 which are spaced apart from each other around and in communication with the main hole portion 313a, which extend from the top surface 311 to the bottom surface 312, and which respectively allow the buffer blocks 12 to move therethrough for protruding outwardly from or retracting downwardly into the top cover 31, a plurality of stop blocks 315 that respectively obstruct upward movements of the limiting blocks 13, and a plurality of counterbore holes 316 that are formed in the top surface 311. The top cover 31 allows the narrowed portion 113 to extend upwardly through the body through hole 313 while stopping the shoulder portion 114 of the surrounding wall 112 from upward movement therefrom. In this embodiment, the top cover 31 has six block through holes 314 that are divided into three hole pairs which are equiangularly disposed about the axis (L), and each of the stop blocks 315 is located between the block through holes 314 in a respective one of the hole pairs.

It is noted that, the number of the buffer blocks 12 and the number of the block through holes 314 may be any positive integers according to actual requirements. Even if the movable unit 1 includes only one buffer block 12 and the top cover 31 has only one block through hole 314 that allow the buffer block 12 to extend therethrough, the object and effect of this disclosure can be achieved as well. Specifically, each of the buffer blocks 12 is a truncated solid that is disposed on the surrounding wall 112, and each of the block through holes 314 is in a shape of a truncated sector for the respective one of the buffer blocks 12 to extend therethrough.

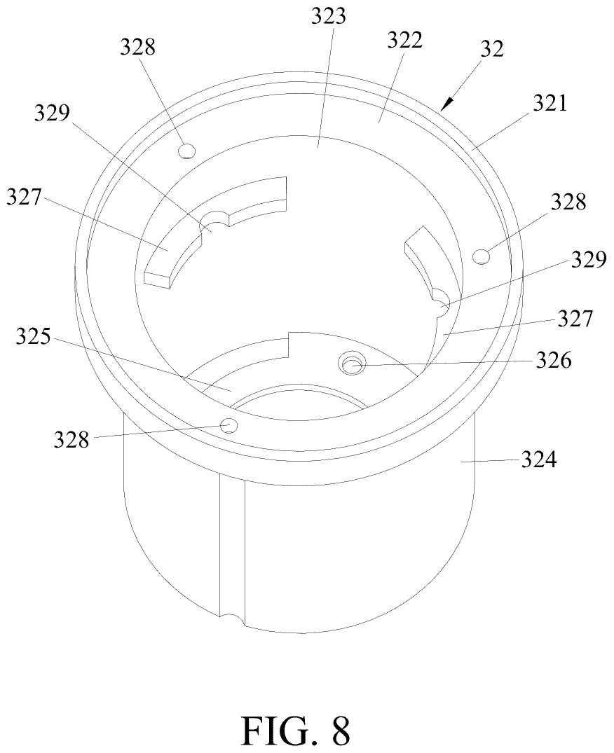

Referring to FIGS. 1, 2, 7, 8, and 9, the outer casing 32 has a top casing wall 321 that surrounds an outer periphery of the top cover 31, a ring-shaped shoulder plate 322 that extends inwardly from a bottom end of the top casing wall 321 in a radially inward direction relative to the axis (L) to support the top cover 31, a bottom casing wall 324 that extends downwardly from an inner periphery of the ring-shaped shoulder plate 322 along the axis (L) and that defines a bottom chamber 323, a bottom wall 325 that is disposed on a bottom end of the bottom casing wall 324, a plurality of insertion holes 326 (only one is visible in FIG. 8 due to the viewing angle) that extend through the bottom wall 325 along the axis (L), a plurality of protrusions 327 that are disposed on the bottom casing wall 324 and that are located in the bottom chamber 323, and a plurality of plate through holes 328 that respective correspond in position to the counterbore holes 316 and that extend through the ring-shaped shoulder plate 322 in a direction parallel to the axis (L). Each of the protrusions 327 has a notch 329 that is in spatial communication with the bottom chamber 323 and that is for a respective one of the protruding ribs 17 to extend therethrough.

Referring to FIGS. 3, 7, and 9, the column legs 33 extend downwardly from the bottom surface 312 of the top cover 31, and are respectively inserted into the curved frame blocks 16. The column legs 33 respectively press against the top surfaces 151 of the guide blocks 15. Each of the column legs 33 has a connecting hole 331 that extends therethrough along the axis (L).

Referring to FIGS. 2, 7, and 9, each of the lock assemblies 34 includes a bolt 341 that extends through a respective one of the plate through holes 328 and a respective one of the counterbore holes 316, and a nut 342 that threadedly engages the bolt 341 and that is located in a respective one of the counterbore holes 316.

Referring to FIGS. 1, 2, 3, and 9, the cleaning unit 4 has a receiving groove 41 that is disposed on the top surface 311 of the top cover 31 and that communicates with the body through hole 313, a cleaner mount 42 that is disposed in the receiving groove 41 and that is fixedly fastened to the top cover 31, and a cleaning member 43 that is disposed on the cleaner mount 42 and that is in contact with the transparent plate 143. The cleaner mount 42 has a fasten block 421 that is disposed in the receiving groove 41 and that is fixedly fastened to the top cover 31 by a plurality of fasteners 44, an engaging groove 422 that is disposed on the fasten block 421, and a plurality of slots 423 that are formed in a top surface of the fasten block 421. The engaging groove 422 has a cross section that is generally in the shape of a 90-degree-rotated T on an imaginary plane parallel to the axis (L). The cleaning member 43 also has a cross section that is generally in the shape of a 90-degree-rotated T on the imaginary plane parallel to the axis (L). The cleaning member 43 includes an engaging block 431 that engages the engaging groove 422, and a cleaning block 432 that extends from the engaging block 431 and away from the cleaner mount 42, and that is in contact with the transparent plate 143. The cleaning block 432 may be a squeegee or a brush.

Referring to FIGS. 2, 6, 7, 8, and 9, the guiding unit 5 includes a plurality of bushings 51 that are respectively and fixedly disposed in the guide holes 153, a plurality of guide rods 52 that extend in the direction parallel to the axis (L), and that extend respectively through the guide holes 153 and respectively through the bushings 51 along the axis (L), and a bottom connecting member 53 that is fixedly connected to the guide rods 52.

Each of the guide rods 52 has a middle insertion segment 521 that extends through the respective one of the guide holes 153 and the respective one of the bushings 51, a top connecting segment 522 that extends upwardly from the middle insertion segment 521 and that is connected to the connecting hole 331 of a respective one of the column legs 33, and a bottom threaded segment 523 that extends downwardly from the middle insertion segment 521, that has a diameter smaller than a diameter of the middle insertion segment 521, and that extends through the bottom connecting member 53. The top connecting segment 522 of each of the guide rods 52 and the connecting hole 331 of the respective one of the column legs 33 may be connected via insertion or threaded connection. Specifically, when they are connected via insertion, the top connecting segment 522 of each of the guide rods 52 serves as a male end and the connecting hole 331 of the respective one of the column legs 33 serves as a female end such that the top connecting segment 522 of each of the guide rods 52 is inserted into the connecting hole 331 of the respective one of the column legs 33. When they are connected via thread connection, the top connecting segment 522 of each of the guide rods 52 serves as a male thread and the connecting hole 331 of the respective one of the column legs 33 serves as a female thread. It is noted that, in one embodiment, the column legs 33 may be omitted and the top connecting segments 522 of the guide rods 52 may be connected to the top cover 31 of the fixing unit 3.

The bottom connecting member 53 is an annular plate, and has a plurality of bottom through holes 531. The bottom threaded segments 523 of the guide rods 52 respectively extend through the bottom through holes 531.

When the embedded electronic device is assembled, the bottom threaded segments 523 of the guide rods 52 are respectively inserted through the bottom through holes 531, and a plurality of nuts 54 that are located at one side of the bottom connecting member 53 opposite to the middle insertion segments 521 of the guide rods 52 are used to threadedly engage the bottom threaded segments 523 so that the guide rods 52 are positioned between the top cover 31 and the bottom connecting member 53 and are able to guide the movable unit 1 to move relative to the top cover 31 of the fixing unit 3 along the axis (L). It is noted that the bottom threaded segments 523 of the guide rods 52 may further be respectively inserted into the insertion holes 326 so that a structural strength of the embedded electronic device may be increased.

The pushing unit 6 resiliently biases the movable unit 1 to move upwardly until the movable unit 1 is stopped and positioned by the top cover 31. The guiding unit 5 and the pushing unit 6 are disposed in the bottom chamber 323. The pushing unit 6 includes a plurality of springs 61 that are respectively sleeved on the guide rods 52. Each of the springs 61 has a top section 611 that abuts against the bottom surface 152 of a respective one of the guide blocks 15, and a bottom section 612 that abuts against the bottom connecting member 53. By virtue of the springs 61 abutting against the guide blocks 15, the pushing unit 6 resiliently biases the movable unit 1 to move upwardly until the upward movements of the limiting blocks 13 are obstructed by the stop blocks 315 so that the movable unit 1 is positioned by the top cover 31.

It is noted that, in one embodiment, the pushing unit 6 may only include at least one resilient member that is mounted between the bottom cover 18 and the bottom connecting member 53, or between the bottom cover 18 and the bottom wall 325 of the outer casing 32, and the at least one resilient member may resiliently bias the movable unit 1 to move upwardly as well.

Furthermore, in one embodiment, the pushing unit 6 may include a plurality of magnets that are mounted to the bottom cover 18 of the movable unit 1 and the bottom wall 325 of the fixing unit 3 so that the pushing unit 6 is able to push the movable unit 1 upwardly by magnetic repulsion.

The light emitting element 7 is mounted to the top wall 111, and is capable of emitting light (e.g., fill light) so that good performance of the electronic module 22 is ensured.

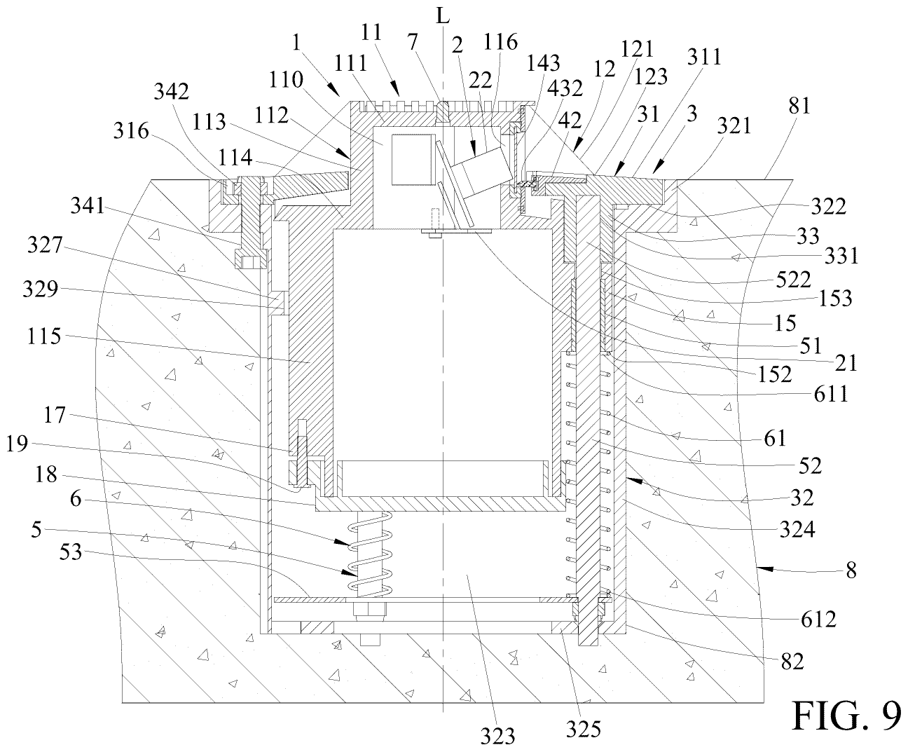

Referring to FIGS. 1 and 9, when the embedded electronic device is assembled, only the top wall 111, the narrowed portion 113 of the surrounding wall, the buffer blocks 12, and the protective plate 14 of the movable unit 1 protrude from the top cover 31. Other components of the movable unit 1, the column legs 33, the guiding unit 5, and the pushing unit 6 are located in the bottom chamber 323 of the outer casing 32. Consequently, the effect of protecting components of the embedded electronic device and reducing the likelihood of malfunction is achieved.

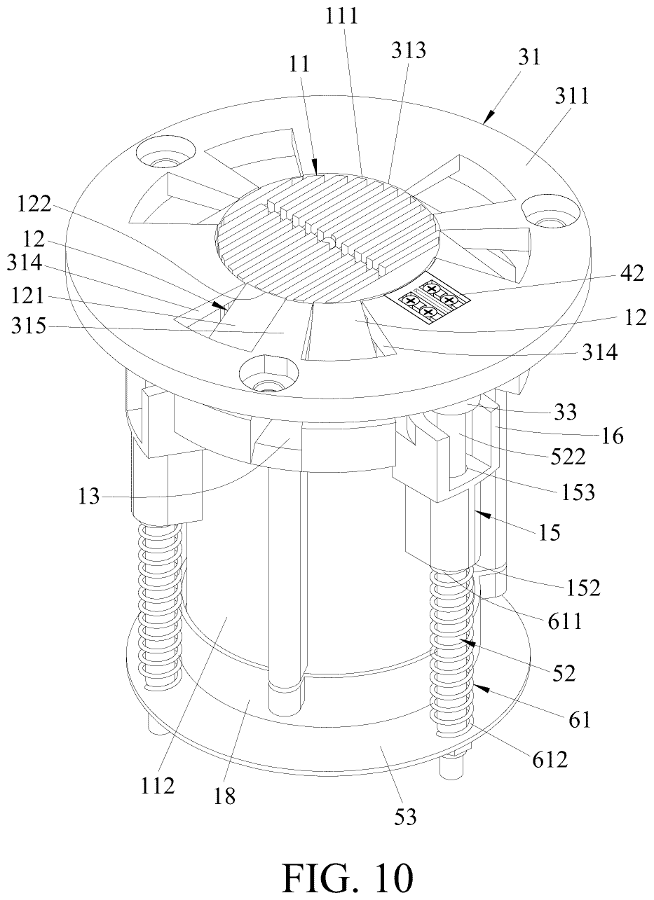

Referring to FIGS. 1, 2, 9, 10, and 11, the movable unit 1 is capable of urging the electronic assembly unit 2 to move relative to the top cover 31 along the axis (L), and is movable relative to the top cover 31 along the axis (L) between an exposed position, in which the movable unit 1 protrudes from the top cover 31, and a hidden position, in which the movable unit 1 retracts into the top cover 31. When the movable unit 1 moves relative to the top cover 31, the cleaning block 432 simultaneously cleans the transparent plate 143.

Referring to FIGS. 1, 2, 6, 7, and 9, when the pushing unit 6 resiliently biases the movable unit 1 to move upwardly until the upward movements of the limiting blocks 13 are obstructed by the stop blocks 315, the movable unit 1 is stopped and positioned by the top cover 31 such that the movable unit 1 is in the exposed position. At this time, the top surfaces 151 of the guide blocks 15 respectively abut against the column legs 33, the outer lower ends 123 of the upward-facing inclined surfaces 121 of the buffer blocks 12 are flush with the top surface 311 of the top cover 31 while the top wall 111 and the window hole 116 of the main body 11, the transparent plate 143, and the buffer blocks 12 protrude from the top surface 311 of the top cover 31, and the electronic module 22 is operable to perform tasks that are related to the external environment via the window hole 116 and the transparent plate 143.

Referring to FIGS. 1, 2, 9, 10, and 11, when an external downward force is exerted on the top wall 111 or the buffer blocks 12, the movable unit 1 is moved to the hidden position and urges the electronic assembly unit 2 to move downwardly along the axis (L). At this time, the top wall 111 and the inner upper ends 122 of the upward-facing inclined surfaces 121 of the buffer blocks 12 are flush with the top surface 311 of the top cover 31, the springs 61 are compressed and store restoring forces, and the electronic assembly unit 2 and the transparent plate 143 are hidden in the fixing unit 3. The transparent plate 143 is cleaned by the cleaning block 432 during downward movement of the movable unit 1.

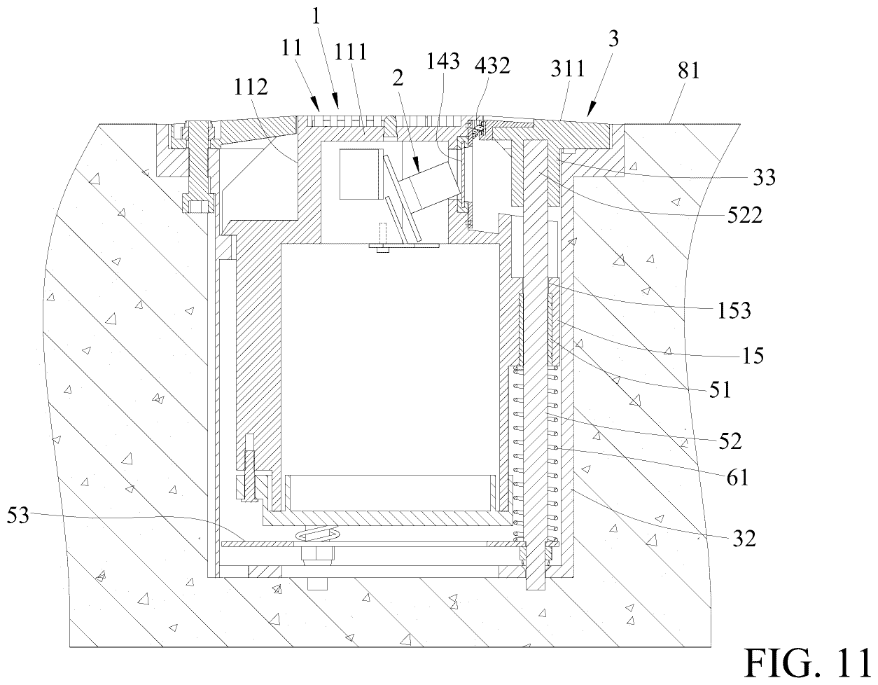

Referring to FIGS. 11 and 9, when the external downward force is released, the pushing unit 6 pushes the movable unit 1 upwardly to the exposed position via the restoring forces, and the transparent plate 143 is cleaned by the cleaning block 432 during upward movement of the movable unit 1.

It is noted that, by virtue of the guiding unit 5, the movable unit 1 may smoothly move between the hidden position and the exposed position. However, in one embodiment, the guiding unit 5 may be omitted.

In order to use the embedded electronic device, referring to FIGS. 1, 9, 10, and 11, first, an accommodation hole 82 that opens upwardly is dug in a ground surface 81 of the ground 8. Next, the fixing unit 3 is placed and fixedly mounted in the accommodation hole 82 such that the ground surface 81 is flush with the top casing wall 321 of the outer casing 32 and the top surface 311 of the top cover 31. At this time, the movable unit 1 is in the exposed position so that the electronic module 22 is operable to perform the tasks that are related to the external environment via the window hole 116 and the transparent plate 143. By virtue of the outer lower ends 123 of the upward-facing inclined surfaces 121 of the buffer blocks 12 being flush with the top surface 311 of the top cover 31 and the ground surface 81, and by virtue of an included angle between the ground surface 81 and each of the upward-facing inclined surfaces 121 being larger than 90 degrees and smaller than 180 degrees, when a vehicle or a pedestrian (not shown) passes the embedded electronic device, the upward-facing inclined surfaces 121 of the buffer blocks 12 may guide the vehicle or the pedestrian to move from the ground surface 81 toward the top wall 111, thereby exerting a downward force to the buffer blocks 12 to urge the movable unit 1 to move toward the hidden position. Consequently, the top wall 111 is flush with the ground surface 81, thereby providing safety to the vehicle or the pedestrian when the vehicle or the pedestrian passes the embedded electronic device, and thereby reducing shock or impact that the embedded electronic device receives when the vehicle or the pedestrian hits the embedded electronic device. Thus, the likelihood of malfunction caused by such potential damage may further be reduced.

When the transparent plate 143 needs to be cleaned, it is only necessary to exert a downward force on the top wall 111 or the buffer blocks 12 (e.g., stepping on the top wall 111 or the buffer blocks 12), the movable unit 1 may be moved to the hidden position while urging the electronic assembly unit 2 to move downwardly, and the transparent plate 143 may simultaneously be cleaned by the cleaning block 432. When the downward force is released, the movable unit 1 is moved upwardly to the exposed position, and the transparent plate 143 is cleaned again by the cleaning block 432 during the upward movement of the movable unit 1.

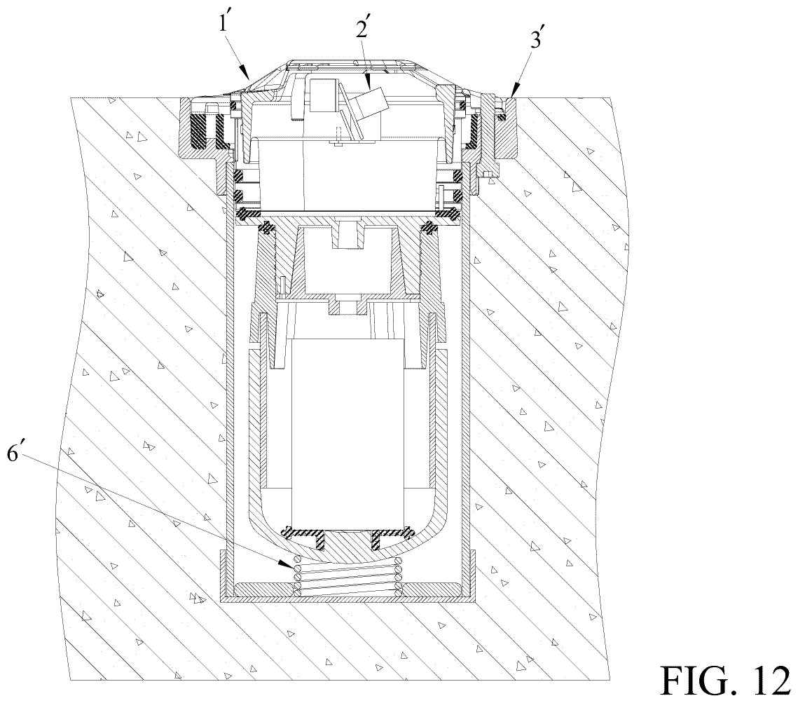

Referring to FIG. 12, a second embodiment of the embedded electronic device according to the present disclosure includes a movable unit 1′, an electronic assembly unit 2′, a fixing unit 3′, and a pushing unit 6′, and is generally similar to the first embodiment. One of the differences between the second and the first embodiments is that a configuration of the movable unit 1′ may allow other components, such as a battery or a cable box, to be mounted to the movable unit 1′.

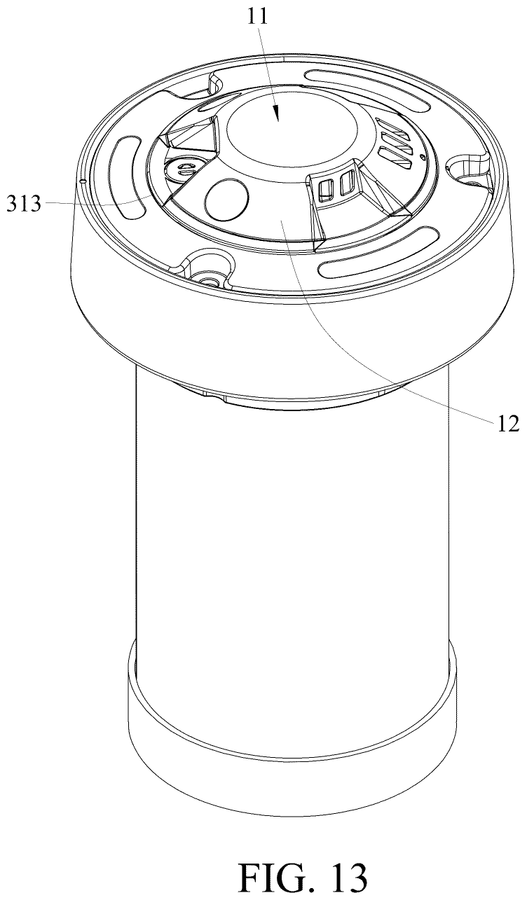

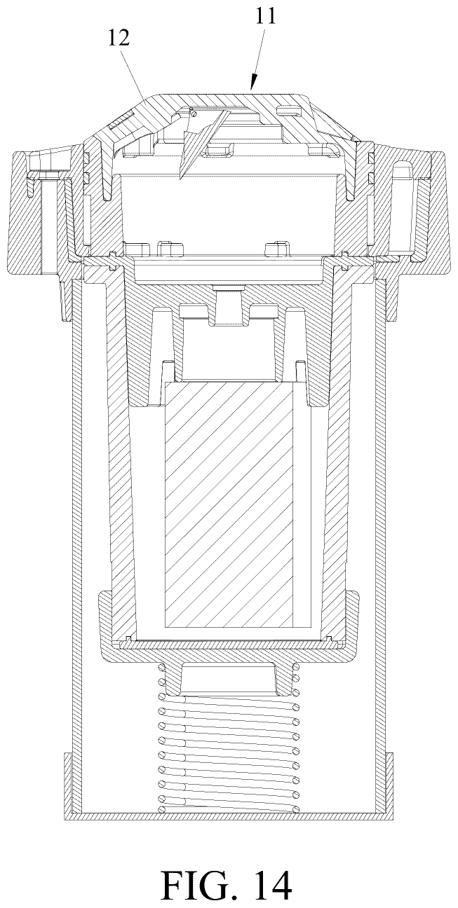

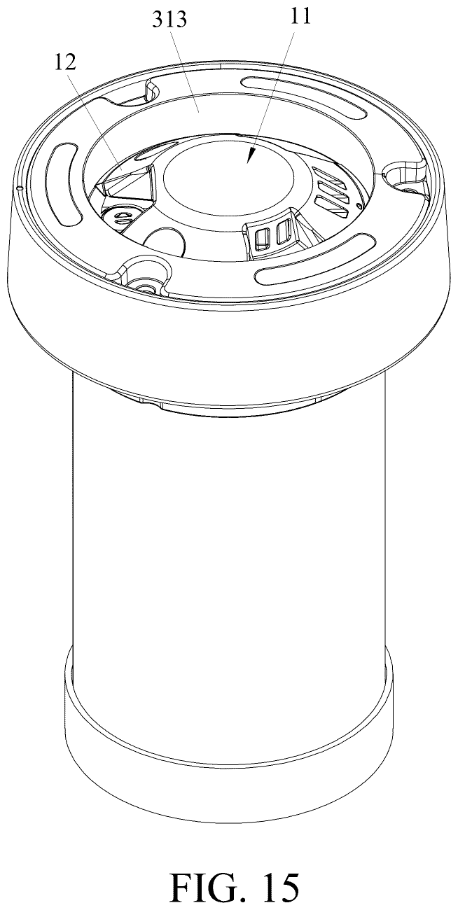

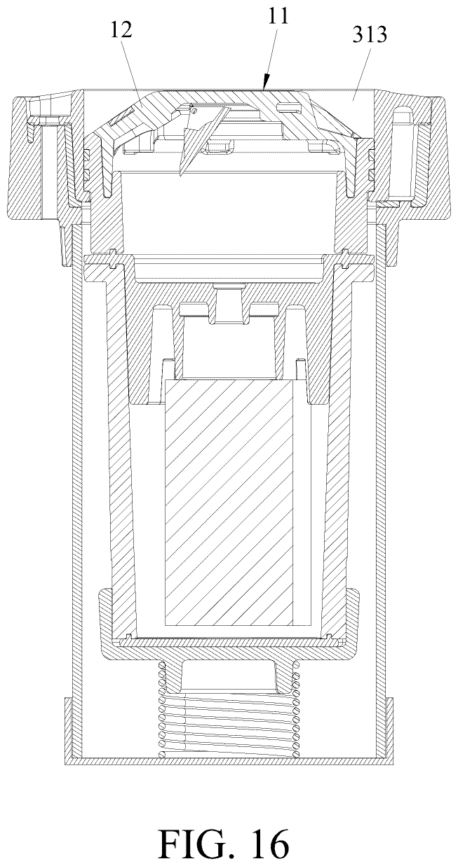

Referring to FIGS. 13 to 16, a third embodiment of the embedded electronic device according to the present disclosure is generally similar to the first embodiment. In the first embodiment, the body through hole 313 of the top cover 31 has the block through holes 314 spaced apart around the middle hole portion 313a, and the top cover 31 further has the stop blocks 315 each of which is located between two adjacent ones of the block through holes 314, whereas the top cover 31 in the third embodiment does not have the block through holes 314 and the stop blocks 315.

The embedded electronic device according to the present disclosure has effects and advantages as follows:

1. The movable unit 1 is movable relative to the top cover 31 along the axis (L) between the exposed position and the hidden position. When the movable unit 1 is in the exposed position, the outer lower ends 123 of the upward-facing inclined surfaces 121 of the buffer blocks 12 are flush with the top surface 311 of the top cover 31 and the ground surface 81, thereby generating a guidance that provides the vehicle or the pedestrian with a safe passage across the embedded electronic device, and thereby reducing the shock or the impact that the embedded electronic device receives when the vehicle or the pedestrian hits the embedded electronic device. Thus, the likelihood of malfunction caused by the potential damage is reduced.

2. By virtue of the electronic module 22 being hidden in the receiving space 110 of the main body 11, and by virtue of the transparent plate 143 of the protective plate 14 sealing the window hole 116, the electronic module 22 is prevented from dirt or being scratched by foreign objects. Furthermore, by virtue of the transparent plate 143 moving relative to the cleaning block 432 along the axis (L) when the movable unit 1 moves relative to the top cover 31 along the axis (L), the transparent plate 143 is cleaned by the cleaning block 432 during the upward or the downward movement of the movable unit 1. Therefore, the transparent plate 143 is kept clean, which ensures good performance of the electronic module 22 when the electronic module 22 performs the tasks related to the external environment via the window hole 116 and the transparent plate 143.

3. By virtue of the bushings 51 being respectively disposed in the guide holes 153 of the guide blocks 15, steadiness and smoothness of the upward and downward movements of the movable unit 1 along the axis (L) are enhanced.

4. When the embedded electronic device is assembled, by virtue of only the top wall 111, the narrowed portion 113 of the surrounding wall, the buffer blocks 12, and the protective plate 14 of the movable unit 1 protruding from the top cover 31, and by virtue of other components of the movable unit 1, the column legs 33, the guiding unit 5, and the pushing unit 6 being located in the bottom chamber 323 of the outer casing 32, the components of the embedded electronic device are protected and the likelihood of malfunction is reduced.

5. By virtue of the column legs 33 being respectively located in the curved frame blocks 16 and respectively pressing against the top surfaces 151 of the guide blocks 15, and by virtue of the protruding ribs 17 respectively extending through the notches 329 of the protrusions 327 and respectively abutting against the protrusions 327, the structural strength of the embedded electronic device is increased.

6. Because the slots 423 are formed in the top surface of the fasten block 421, the top surface of the fasten block 421 is non-planar. Therefore, rainwater is prevented from directly splashing onto the window hole 116 and the transparent plate 143 after the rainwater drops onto the fasten block 421, which may ensure good performance of the electronic module 22.

In summary, the purpose of the present disclosure may indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An embedded electronic device comprising:
a movable unit including a main body and at least one buffer block, the main body having a top wall, and a surrounding wall that extends downwardly from a periphery of the top wall, that has a bottom end opposite to the top wall, and that surrounds an axis of the main body, the top wall and the surrounding wall cooperatively defining a receiving space, the at least one buffer block being disposed on the surrounding wall and having an upward-facing inclined surface that has an inner upper end which is proximate to the top wall and an outer lower end which is lower than and more distant from the axis compared to the inner upper end, the upward-facing inclined surface being inclined downwardly and outwardly from the inner upper end to the outer lower end to extend away from the axis;
an electrical assembly unit fixedly connected to the main body and located in the receiving space, and including an electronic module;
a fixing unit including a top cover that covers the main body, the top cover having a body through hole that allows the main body and the at least one buffer block to move therethrough for protruding upwardly from or retracting downwardly into the top cover; and
a pushing unit resiliently biasing the movable unit to move upwardly until the movable unit is stopped and positioned by the top cover;
wherein the movable unit is movable relative to the top cover of the fixing unit along the axis between a hidden position, in which the movable unit retracts into the top cover, and an exposed position, in which the movable unit protrudes from the top cover.

2. The embedded electronic device as claimed in claim 1, further comprising a guiding unit, the guiding unit including a plurality of guide rods that extend through the movable unit along the axis, each of the plurality of guide rods having a middle insertion segment, and a top connecting segment that is connected to the fixing unit.

3. The embedded electronic device as claimed in claim 2, wherein the movable unit further includes a plurality of guide blocks that are disposed on the surrounding wall, each of the plurality of guide blocks having a guide hole that extends therethrough along the axis, the plurality of guide rods respectively extending through the guide holes of the plurality of guide blocks, the guiding unit further including a bottom connecting member that is fixedly connected to the plurality of guide rods.

4. The embedded electronic device as claimed in claim 3, wherein the guiding unit further includes a plurality of bushings that are respectively located in the guide holes of the plurality of guide blocks, the plurality of guide rods respectively extending through the plurality of bushings.

5. The embedded electronic device as claimed in claim 3, wherein the pushing unit includes a plurality of springs that are respectively sleeved on the plurality of guide rods, each of the plurality of springs having a top section that abuts against a respective one of the plurality of guide blocks, and a bottom section that abuts against the bottom connecting member.

6. The embedded electronic device as claimed in claim 3, wherein the surrounding wall has a narrowed portion that extends downwardly from the periphery of the top wall along the axis, a shoulder portion that extends from a bottom end of the narrowed portion in a radially outward direction relative to the axis, and a broadened portion that extends downwardly from an outer periphery of the shoulder portion toward the bottom end of the surrounding wall, the plurality of guide blocks being disposed on an outer surface of the broadened portion, the movable unit further including a plurality of curved frame blocks, the plurality of curved frame blocks being disposed on the outer periphery of the shoulder portion, and respectively extending upwardly from the plurality of guide blocks, the fixing unit further including a plurality of column legs that extend downwardly from the top cover, the plurality of column legs being respectively located in the plurality of curved frame blocks and respectively pressing against the plurality of guide blocks, each of the plurality of column legs having a connecting hole that is connected to the top connecting segment of a respective one of the plurality of guide rods.

7. The embedded electronic device as claimed in claim 2, wherein the fixing unit further includes an outer casing in which the top cover is located, the outer casing having a top casing wall that surrounds an outer periphery of the top cover, a ring-shaped shoulder plate that extends inwardly from a bottom end of the top casing wall in a radially inward direction relative to the axis to support the top cover, and a bottom casing wall that extends downwardly from an inner periphery of the ring-shaped shoulder plate and that defines a bottom chamber, the guiding unit and the pushing unit being disposed in the bottom chamber.

8. The embedded electronic device as claimed in claim 1, wherein the movable unit further includes a plurality of limiting blocks that are disposed on the surrounding wall, the top cover further having a plurality of stop blocks that respectively obstruct upward movements of the plurality of limiting blocks.

9. The embedded electronic device as claimed in claim 1, wherein the surrounding wall of the main body has a window hole that extends in a radial direction relative to the axis, the movable unit further including a protective plate that is fixedly connected to the surrounding wall, the protective plate including a transparent plate that seals the window hole.

10. The embedded electronic device as claimed in claim 9, further comprising a cleaning unit that includes a cleaner mount which is fixedly connected to the top cover, and a cleaning member which is disposed on the cleaner mount and which is in contact with the transparent plate.

11. The embedded electronic device as claimed in claim 1, wherein the movable unit further includes a bottom cover that is fixedly connected to the bottom end of the surrounding wall.

12. The embedded electronic device as claimed in claim 1, wherein the surrounding wall of the main body has a narrowed portion that extends downwardly from the periphery of the top wall to extend around the axis, a shoulder portion that extends from a bottom end of the narrowed portion in a radially outward direction relative to the axis, and a broadened portion that extends downwardly from an outer periphery of the shoulder portion toward the bottom end of the surrounding wall, the at least one buffer block including a plurality of buffer blocks that are angularly spaced apart around the narrowed portion of the surrounding wall, each of the plurality of buffer blocks having the inner upper end that is disposed in close proximity to the periphery of the top wall and the outer lower end that is disposed in close proximity to the outer periphery of the shoulder portion.

13. The embedded electronic device as claimed in claim 12, wherein the body through hole of the top cover has a main hole portion and a plurality of block through holes that are spaced apart from each other around and in communication with the main hole portion and that respectively allow the plurality of buffer blocks to extend therethrough, the top cover allowing the narrowed portion to extend upwardly through the body through hole while stopping the shoulder portion from upward movement therefrom.

14. The embedded electronic device as claimed in claim 12, wherein the electronic module is disposed in the narrowed portion of the surrounding wall, the narrowed portion having a window hole that extends in a radial direction relative to the axis near the electronic module.
